(19) United States
(12) Patent Application Publication
(10) Pub. No.: US 2026/0323204 A1
(43) Pub. Date: Oct. 15, 2026

(54) SOUND ABSORBING MATERIAL, SOUND PRODUCTION APPARATUS AND ELECTRONIC DEVICE

(71) Applicant: Goertek Inc., Shandong (CN)

(72) Inventors: Quanquan Pan, Shandong (CN); Chun Li, Shandong (CN); Cuicui Wang, Shandong (CN); Chengfei Zhang, Shandong (CN); Chunfa Liu, Shandong (CN); Fengguang Ling, Shandong (CN)

(73) Assignee: Goertek Inc., Shandong (CN)

(21) Appl. No.: 18/996,941

(22) PCT Filed: Feb. 24, 2023
(86) PCT No.: PCT/CN2023/078109

§ 371 Date: Jan. 17, 2025

(30) Foreign Application Priority Data
Nov. 15, 2022 (CN) 202211420264.3

(51) Int. Cl. H04R 1/28; H04R 1/02

(52) U.S. Cl. CPC H04R 1/288; H04R 1/028

(57) ABSTRACT

The present disclosure provides a sound absorption material, a sound producing device, and an electronic equipment. The sound absorption material comprises zeolite powder particles and inorganic adhesive; the zeolite powder particles have an average particle size>10 μm, and a silicon-to-aluminum mass ratio<200; the inorganic adhesive is used to bind a plurality of zeolite powder particles into the sound absorption material 1, and the sound absorption material has a crushing resistance in a range of 0.1N to 5N.

### CROSS-REFERENCE TO RELATED APPLICATIONS

The present disclosure is a National Stage of International Application No. PCT/CN2023/078109, filed on Feb. 24, 2023, which claims priority to Chinese Patent Application No. 202211420264.3, filed on Nov. 15, 2022, both of which are hereby incorporated by reference in their entireties.

### TECHNICAL FIELD

The present disclosure relates to the field of acoustic technology, and more specifically, to a sound absorption material, a sound producing device, and an electronic equipment.

### BACKGROUND

In recent years, with the increasing trend towards lightweight and thinness in electronic products, the space available for a speaker has become increasingly limited. Consequently, the speaker has become flatter, leading to a significant reduction in the volume of its rear acoustic cavity and impacting the low-frequency performance of the speaker. To address this issue, existing technologies use porous materials (such as activated carbon, zeolite powder, active silicon dioxide, porous alumina, molecular sieves, or mixtures prepared according to specific types and ratios, etc.) to create sound absorbing particles that are filled into the rear cavity of the speaker. These materials utilize the internal pore structure to rapidly adsorb and desorb the gas in the rear cavity of the speaker, achieving a virtual increase in the resonant space of the rear acoustic cavity of the speaker. This effectively reduces the resonant frequency F0 of the speaker and enhances the low-frequency sensitivity of the speaker.

Currently, the porous materials are often bound into granular sound absorbing particles using organic adhesives. However, organic adhesives are prone to adsorbing organic molecules, which can not only cause blockage of the pores among the sound absorbing particles but also lead to issues such as oxidation, aging, and insufficient binding strength over time, which severely affects the particle strength of the sound absorbing particles, and results in poor sound absorbing effect. Moreover, existing sound absorbing powder particles are stacked into sound absorbing particles with a dense structure and a small pore volume in the macroporous structure, which prevents the sound absorbing powder particles inside the sound absorbing particles from functioning effectively, leading to the waste of acoustic materials.

### SUMMARY

An objective of the present disclosure is to provide new solutions for a sound absorption material, a sound producing device, and an electronic equipment, for dealing with the problem of insufficient strength in the sound absorption material made in the prior art.

According to a first aspect of the present disclosure, a sound absorption material is provided, comprising:
zeolite powder particles with an average particle size being >10 μm and a silicon-to-aluminum mass ratio being <200;
inorganic adhesive used to bind a plurality of zeolite powder particles into the sound absorption material, the sound absorption material having a crushing resistance in a range of 0.1N to 5N.

Optionally, in a temperature range of −40° C. to 200° C., a change rate of the crushing resistance of the sound absorption material is ≤10%.

Optionally, the sound absorption material has macroporous structures with an average pore size being ≥100 nm.

Optionally, a pore volume of the macroporous structures accounts for at least 50% of a total pore volume of the sound absorption material.

Optionally, a crystallinity of the zeolite powder particles is ≥80%.

Optionally, a specific surface area of the zeolite powder particles is ≥100 m²/g.

Optionally, the zeolite powder particles have pore structures with a pore size of 0.5 nm to 3 nm.

Optionally, the zeolite powder particles have at least one of a MOR, MFI, or FER crystal structure.

Optionally, a mass of the inorganic adhesive accounts for 1% to 30% of a total mass of the sound absorption material.

Optionally, the inorganic adhesive is prepared from at least one of inorganic salts, inorganic acids, inorganic bases, metal oxides, and hydroxides.

Optionally, a bulk density of the sound absorption material is ≥0.3 g/ml.

Optionally, the sound absorption material is quasi-spherical, ellipsoidal, rod-like, cubic, or irregularly shaped;

in a case where the sound absorption material is quasi-spherical, a diameter of the sound absorption material is 100 μm to 800 μm.

Optionally, the sound absorption material further comprises a dispersant;

the dispersant is at least one of sodium dodecyl sulfate, dodecyl benzenesulfonic acid sodium, tri-ethyl-hexyl phosphate, methyl-pentanol, polyacrylamide, fatty acid polyethylene glycol ester, and polyether.

Optionally, a mass ratio of the dispersant in a total mass of the sound absorption material is ≤10%.

According to a second aspect of the present disclosure, a sound producing device is provided, comprising:
a sound producing unit, a housing, and the sound absorption material according to the first aspect;
the sound producing unit is located inside the housing and cooperates with the housing to define a front acoustic cavity and a rear acoustic cavity, and the sound absorption material is filled in the rear acoustic cavity and/or the front acoustic cavity.

According to a third aspect of the present disclosure, an electronic equipment is provided, comprising the sound producing device according to the second aspect.

According to an embodiment of the present disclosure, the present disclosure uses the inorganic adhesive to bind the zeolite powder particles with a silicon-to-aluminum mass ratio less than 200 and an average particle size being >10 μm into the sound absorption material with a crushing resistance in a range of 0.1N to 5N. On the one hand, the zeolite powder particles with a silicon-to-aluminum mass ratio less than 200 have more aluminum atoms, resulting in more negative charges and increased polar sites on the zeolite powder particles. After binding with the inorganic adhesive, they have better binding strength, such that the sound absorption material can withstand vibrations of higher power intensities, thereby greatly improving the strength of the sound absorption material, and ensuring the acoustic performance of the sound absorption material.

On the other hand, after the zeolite powder particles with an average particle size greater than 10 μm are bound into the sound-absorbing material, it has more macroporous structures inside, which facilitates the entry/exit of the air molecules into/out the macroporous structures in the sound-absorbing material, such that the zeolite powder particles inside it may fully adsorb and desorb the air molecules, thereby increasing the utilization rate of the zeolite powder particles in the sound absorption material and improving the acoustic performance of the sound absorption material. Moreover, the inorganic adhesive forms its own pore structures after drying, which may further improve the acoustic performance of the sound absorption material.

Other features of the present disclosure and advantages thereof will become clear by the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 is a structural schematic diagram of a zeolite powder particle provided by the present disclosure.

FIG. 2 is a structural schematic diagram of a sound absorption material provided by the present disclosure.

FIG. 3 is a structural schematic diagram of a sound producing device provided by the present disclosure.

FIG. 4 is a IMP curve of a fourth sound producing device provided by the present disclosure.

FIG. 5 is IMP curves of various sound producing devices provided by the embodiment 1, the embodiment 2, and the comparative embodiment.

1. sound absorption material; 11. pore structure; 12. macroporous structure; 10. housing; 101. rear acoustic cavity; 102. front acoustic cavity; 20. sound producing unit.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

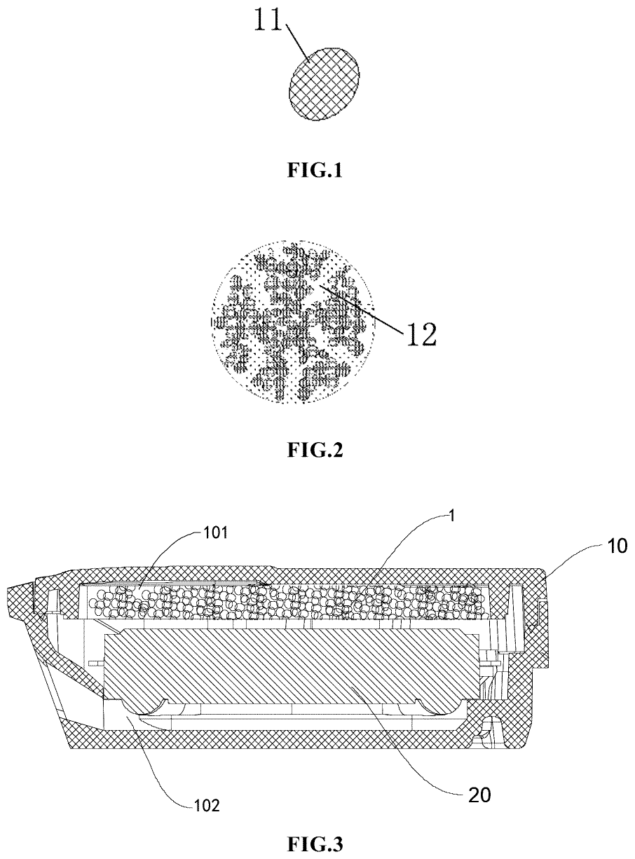

As shown in FIGS. 1 to 2, the present disclosure provides a sound absorption material 1, comprising: zeolite powder particles and inorganic adhesive; the zeolite powder particles have an average particle size being >10 μm, and a silicon-to-aluminum mass ratio being <200; the inorganic adhesive is used to bind a plurality of zeolite powder particles into the sound absorption material 1, and the sound absorption material 1 has a crushing resistance in a range of 0.1N to 5N.

Specifically, the sound absorption material 1 provided by the present disclosure is formed by binding the zeolite powder particles with the average particle size being >10 μm and the silicon-to-aluminum mass ratio being <200 using the inorganic adhesive. Here, when these zeolite powder particles with the particle size greater than 10 μm are bound into the sound absorption material 1, more macroporous structures 12 may be generated, which facilitates the entry/exit of air molecules into/out the internal structure of the sound absorption material 1, such that it is easier for the material to adsorb and desorb air molecules, thereby increasing the utilization rate of the internal pore structure 11 of the sound absorption material 1 and enhancing the sound absorbing performance of the material. Additionally, the inorganic adhesive used in the present disclosure forms its own pore structures 11 after drying, which further increases the number of pore structures 11 in the sound absorption material 1 formed by binding the zeolite powder particles, thereby further enhancing the sound absorbing performance of the sound absorption material 1.

Here, when the average particle size of the zeolite powder particles is in a range of 15 μm to 20 μm, such as 16 μm, 18 μm, etc., the curvature or rough structure on the surface of the zeolite powder particles may facilitate the formation of the macroporous structures 12 with a pore size ranging from 100 nm to 6000 nm between the particles or between the zeolite powder particles and the inorganic adhesive. The macroporous structures 12 in this range are more suitable for air molecules to smoothly pass through it and into the microporous structure inside the sound absorption material 1, further improving the utilization rate of the internal material of the sound absorption material 1.

In existing technologies, the sound absorbing particles made by binding the zeolite powder particles with a higher silicon-to-aluminum mass ratio using the organic adhesive are prone to issues such as adhesive oxidation and aging when used for a long time in high-temperature and high-humidity environments, which can easily lead to the breakdown of sound absorbing particles or blockage of pores. This affects the use and acoustic performance of the sound producing device when the sound absorbing particles are filled into the sound producing device.

In the present embodiment, by using the inorganic adhesive to bind the zeolite powder particles with a silicon-to-aluminum mass ratio less than 200 into the sound absorption material 1, on the one hand, the zeolite powder particles with a silicon-to-aluminum mass ratio less than 200 have more aluminum atoms, resulting in more negative charges and increased polar sites on the zeolite powder particles. After binding with the inorganic adhesive, they have better binding strength, greatly improving the strength of the sound absorption material 1, such that the sound absorption material 1 has a the crushing resistance reaching 0.1N to 5N and enables it to withstand vibrations of higher power intensities, thereby ensuring the acoustic performance of the sound absorption material 1. On the other hand, the inorganic adhesive does not experience a decrease in binding strength over time or due to high temperature and humidity in the environment, which further improves the strength of the sound absorption material 1. Moreover, the inorganic adhesive forms its own pore structures 11 after drying, which may further improve the acoustic performance of the sound absorption material 1.

Preferably, the silicon-to-aluminum mass ratio in the zeolite powder particles is in a range of 150 to 180, such as 160, 175, etc. The zeolite powder particles in this range form a more reasonable number of polar sites, which not only allows for more uniform binding of each zeolite powder particle through the inorganic adhesive but also prevents the formation of too many polar sites, leading to an excess of inorganic adhesive combined with each zeolite powder particle, affecting the overall strength of the sound absorption material 1 or clogging the pore structures 11 formed by the sound absorption material 1.

The sound absorption material 1 provided by the present disclosure is filled in the sound producing device, and since the sound absorption material 1 has higher strength and more abundant pore structures 11, it is not prone to issues such as the crushing, dusting, or pore blockage of the sound absorption material 1 during the use of the sound producing device, and the sound absorption material 1 may also provide excellent sound absorbing effect, thereby improving the acoustic performance of the sound producing device.

Optionally, in a temperature range of −40° C. to 200° C., the change rate of the crushing resistance of the sound absorption material 1 is ≤10%.

Specifically, in the present embodiment, the change rate of the crushing resistance of the sound absorption material 1 refers to the ratio of the difference in the crushing resistance of the sound absorption material 1 before and after treatment of the sound absorption material 1 to the crushing resistance before treatment, within the above temperature range, and may reflect the resistance of the sound-absorbing material 1 to a high-temperature environment to some extent. In practical applications, the operating environment for the sound producing device typically falls within a temperature range of −40° C. to 200° C. Under this temperature condition, the change rate of the crushing resistance of the sound absorption material 1 is limited to not exceed 10%, such as 8%, 5%, 3%, such that when the sound absorption material 1 is filled in the sound producing device, the sound producing device has higher environmental adaptability, thereby avoiding that the sound absorption material 1 is broken due to environmental changes in extreme conditions to affect the sound performance of the sound producing device.

Optionally, the sound absorption material 1 has macroporous structures 12, with an average pore size being ≥100 nm.

Specifically, in the present embodiment, the sound absorption material 1 is bound by using the zeolite powder particles with a particle size greater than 10 μm, resulting in a material with a greater number of macroporous structures 12, which facilitates the entry/exit of air molecules into/out the internal pores of the sound absorption material 1, and improves the material utilization rate of the sound absorption material 1. Furthermore, when the average pore size of the macroporous structure 12 is greater than or equal to 100 nm, it may reduce the resistance of air molecules entering into the pores, increases the passage rate of air molecules, and makes the adsorption and desorption of air molecules by the sound absorption material 1 smoother, thereby further enhancing the sound absorbing performance of the material.

When the pore size of the macroporous structure 12 is in the range of 100 nm to 6000 nm, such as 200 nm, 300 nm, 500 nm, 800 nm, 1000 nm, 1500 nm, etc., it may provide a reasonable number of macroporous structures 12, such that there are not too few macroporous structures 12 to hinder air molecules from entering into the internal microporous structure through the macroporous structures 12, and at the same time there are not too many macroporous structures 12 to cause issues such as incomplete internal structure and collapse of the sound absorption material 1, thereby further enhancing the sound absorbing performance of the material.

Optionally, a pore volume of the macroporous structures 12 accounts for at least 50% of a total pore volume of the sound absorption material 1.

Specifically, the more macroporous structures 12 there are and the larger the pore size of the macroporous structures 12, the greater the pore volume of the macroporous structures, which enhances the ability of the sound absorption material 1 to adsorb and desorb the air molecules. Therefore, by increasing the proportion of the pore volume of the macroporous structures 12 in the sound absorption material 1, it is possible to allow the air molecules to be rapidly adsorbed or desorbed by the macroporous structure 12, thereby providing a structural basis for the sound absorbing effect of the sound absorption material 1. In the present disclosure, the average particle size of the zeolite powder particles is >10 μm, which allows the pore volume of the macroporous structures 12 to be set at more than 50%, significantly enhancing the sound absorbing effect of the sound absorption material 1. Furthermore, the pore volume of the macroporous structures 12 may account for 50%, 55%, 60%, 65%, 70%, and 75% of the total pore volume of the sound absorption material 1, etc.

Optionally, a crystallinity of the zeolite powder particles is ≥80%.

Specifically, the higher the crystallinity of the zeolite powder particles, the more regular the internal pore structures, and the stronger the ability to adsorb and desorb the air molecules. In the present embodiment, the crystallinity of the zeolite powder particles is limited to above 80%, such as 85%, 90%, 95%, etc., to ensure that the pore structure 11 formed inside the zeolite powder particles is more regular, enhancing its ability to adsorb and desorb the air molecules, increasing the utilization rate of the internal material of the sound absorption material 1, and making the acoustic performance of the sound absorption material 1 formed by binding the zeolite particles is more excellent.

Optionally, a specific surface area of the zeolite powder particles is ≥100 m²/g.

Specifically, in the present embodiment, the larger the specific surface area of the zeolite powder particles, the richer the internal pore structure 11, and the resulting sound absorption material 1 will have more and richer pore structures 11, resulting in better sound absorbing effect. By limiting the specific surface area of the zeolite powder particles to a range greater than or equal to 100 m²/g, such as 200 m²/g, 300 m²/g, etc., it is not only to provide more pore structures 11 for the sound absorption material 1, but also to facilitate the mutual binding of the inorganic adhesive and the zeolite powder particles, thereby enhancing the strength of the sound absorption material 1.

Optionally, the zeolite powder particles have pore structures 11 with a pore size of 0.5 nm to 3 nm.

Specifically, in the present embodiment, the pore structure 11 with different pore sizes within the zeolite powder particles plays a different role in the sound absorbing performance of the resulting sound absorption material 1. In the present embodiment, the zeolite powder particles have pore structures 11 with a pore size of 0.5 nm to 3 nm, such as 0.6 nm, 1 nm, 1.5 nm, 2 nm, etc., resulting in a sound absorption material 1 with better sound absorbing effect. Preferably, the pore size of the pore structures 11 of the zeolite powder particles is 0.5 nm to 0.9 nm, and the pore structures 11 in this range allow each pore structure 11 of the resulting sound absorption material 1 to accommodate at least 2 to 3 air molecules, achieving better sound absorbing effect.

Optionally, the zeolite powder particles have at least one of a MOR, MFI, or FER crystal structure.

Specifically, different crystal structures affect the ability of the zeolite powder particles to adsorb and desorb the air molecules, and the more regular the crystal structure, the more regular the resulting pore structure 11 will be, making it smoother for the air molecules to enter into and exit out the sound absorption material 1. In the present embodiment, the zeolite powder particles adopt the MOR, MFI, or FER crystal structure, provide pore structures that are conducive to the adsorption and desorption of the air molecules, are regular in structure, and possess higher sound absorbing performance.

Optionally, a mass of the inorganic adhesive accounts for 1% to 30% of a total mass of the sound absorption material 1.

Specifically, the use of the inorganic adhesive may, on the one hand, enhance the binding force between the zeolite powder particles without a decrease in bonding strength over time, and on the other hand, form the porous structures 11 after drying of the zeolite powder particles, which is beneficial to the sound absorbing performance of the sound absorption material 1. In practical applications, an insufficient amount of the inorganic adhesive may lead to inadequate binding force between the zeolite powder particles, causing the resulting sound absorption material 1 being prone to fragmentation. At the same time, an excessive amount of the inorganic adhesive should also be avoided, as it could envelop the zeolite powder particles and affect the sound absorbing effect of the resulting sound absorption material 1. In the present embodiment, by limiting the amount of the inorganic adhesive to 1% to 30%, it is possible to take into account both the strength and sound absorbing performance of the sound absorption material 1.

Additionally, in the above range, the impact of an addition amount of the inorganic adhesive on the crushing resistance of the sound absorption material 1 increases as the addition amount increases. By limiting the mass of the inorganic adhesive to 3% to 10% of the total mass of the sound absorption material 1, for example, 3%, 4%, 5%, 6%, 7%, 8%, etc., it is possible to avoid the problem that the inorganic adhesive occupies the space of the zeolite powder particles due to the excessive inorganic adhesive and reduces the sound absorption effect of sound-absorbing material 1. Moreover, since the strength of the inorganic adhesive is lower than that of the zeolite powder particles, the excessive inorganic adhesive would affect the overall strength of the sound absorption material 1. The inorganic adhesive in this range may ensure that the crushing resistance of the sound absorption material 1 may reach more than 0.4N, and the sound absorbing performance is improved.

Optionally, the inorganic adhesive is prepared from at least one of inorganic salts, inorganic acids, inorganic bases, metal oxides, and hydroxides.

Specifically, in the present embodiment, the inorganic adhesive may be made of silicate sol, aluminate sol, phosphate sol, borate sol, sulfate sol, magnesia-alumina silicate sol, various metal oxide sols, etc., which is not limited in the present disclosure. The above inorganic adhesive all have good binding property and have own porous structures 11 after drying, which is conducive to the sound absorbing function of the sound absorption material 1.

Optionally, a bulk density of the sound absorption material 1 is ≥0.3 g/ml.

Specifically, the particle size of the zeolite powder particles affects their own bulk density, and after being bound into the sound absorption material 1, it also affects the bulk density of the sound absorption material 1. The magnitude of the bulk density of the sound absorption material 1 affects the performance of adsorbing and desorbing air. In the present disclosure, the particle size of the zeolite powder particles is relatively large, and the bulk density of the resulting sound absorption material 1 is relatively small. In practical applications, a relatively small bulk density means that when the sound absorption material 1 is filled in a certain volume, the filled mass is relatively small, which weakens the performance of reducing the resonant frequency of the sound producing device. In the present embodiment, the bulk density of the sound absorption material 1 is set to be greater than or equal to 0.3 g/ml, for example, 0.5 g/ml, 0.6 g/ml, 1 g/ml, etc., to ensure the sound absorbing performance of the sound absorption material 1 when filled in the sound producing device.

Optionally, the sound absorption material 1 may be quasi-spherical, ellipsoidal, rod-shaped, block-shaped, or irregular block-shaped; in the case where the sound absorption material 1 is quasi-spherical, the diameter of the sound absorption material 1 is 100 μm to 800 μm.

Specifically, in the present embodiment, the sound-absorbing material 1 may use the inorganic adhesive to bind the zeolite powder particles into desired shapes such as particles, blocks, etc. according to actual needs. For example, in one embodiment, the sound absorption material 1 is bound into quasi-spherical granules with a diameter defined as 100 μm to 800 μm, such as 110 μm, 120 μm, 150 μm, 200 μm, 400 μm, 500 μm, etc., such that the sound absorption material 1, when filled in the rear acoustic cavity 101 of the sound producing device, has an appropriate filling amount to improve its sound absorbing performance. Additionally, irregular block shape may be matched with the shape of the rear acoustic cavity 101 of the sound producing device to form an overlaying block shape, which may further enhance the structural strength of the sound absorption material 1.

Optionally, the sound absorption material 1 further comprises a dispersant; the dispersant is at least one of sodium dodecyl sulfate, dodecyl benzenesulfonic acid sodium, tri-ethyl-hexyl phosphate, methyl-pentanol, polyacrylamide, fatty acid polyethylene glycol ester, and polyether.

Specifically, a dispersant is a preparation that can cause powdery materials to be uniformly dispersed in a medium to form a stable suspension. If adding a dispersant when preparing the sound absorption material 1, it will help the zeolite powder particles to be more uniformly dispersed in water and improve the uniformity of the mixture with the inorganic adhesive, such that the properties of the resulting sound absorption material 1 are more consistent. In the present embodiment, sodium dodecyl sulfate, dodecyl benzenesulfonic acid sodium, tri-ethyl-hexyl phosphate, methyl-pentanol, polyacrylamide, fatty acid polyethylene glycol ester, or polyether may be used as the dispersant, and some fiber-derived substances may also be used as the dispersant, which is not limited in the present disclosure.

Optionally, a mass ratio of the dispersant in a total mass of the sound absorption material 1 is ≤10%.

Specifically, the addition of the dispersant is beneficial for forming the sound absorption material 1 with uniform properties, but an excessive addition amount may lead to the blockage of the pore structure 11 of the zeolite powder particles, or affect the adhesion of the inorganic adhesive to the zeolite powder particles, ultimately affecting the sound absorbing performance of the sound absorption material 1. In the present embodiment, the addition amount of the dispersant is controlled within 10%, such as 8%, 5%, 2%, etc., to balance the property consistency of the sound absorption material 1 and its sound absorbing performance, thereby enhancing its acoustic performance.

According to a second aspect of the present disclosure, a sound producing device is provided, as shown in FIG. 3, which comprises: a sound producing unit 20, a housing 10, and the sound absorption material 1 described in the first aspect; the sound producing unit 20 is located inside the housing 10 and cooperates with the housing 10 to define a front acoustic cavity 102 and a rear acoustic cavity 101, and the sound absorption material 1 is filled in the rear acoustic cavity 101 and/or the front acoustic cavity 102. That is to say, the sound absorption material 1 may be filled in the front acoustic cavity 102 or in the rear acoustic cavity 101. When the sound absorption material 1 is filled in the front acoustic cavity 102, it is possible to increase the damping inside the front acoustic cavity 102, thereby reducing the distortion peak of the sound producing device and effectively suppressing the harmonic distortion and high-frequency noise caused by high-order resonance. When the sound absorption material 1 is filled in the rear acoustic cavity 101, the macropores, meso-pores, and micropores in the sound absorption material 1 may play a good sound absorbing effect, and increase the virtual volume of the rear acoustic cavity 101, thereby enhancing the low-frequency effect of the sound producing device.

Specifically, in the present embodiment, by filling the sound absorption material 1 provided by the first aspect of the present disclosure in the front acoustic cavity 102 and/or the rear acoustic cavity 101 of the sound producing device, on one hand, the sound absorption material 1 provided by the present disclosure has high strength and high environmental tolerance, such that the sound absorption material 1 filled in the sound producing device is not prone to breaking during use, thereby preventing the sound absorption material 1 from being powdered to affect the acoustic performance of the acoustic device. On the other hand, the sound absorption material 1 provided by the present disclosure has a higher sound absorbing effect, and further enhances the sound producing effect of the sound producing device. Here, the sound absorption material 1 may be made into granular form to be filled in the sound producing device, or be made into block-shaped material, which matches the shape of the front acoustic cavity 102 or the rear acoustic cavity of the sound producing device, to be placed into the sound producing device. The specific form may be made according to actual needs, and is not limited in the present disclosure.

According to the third aspect of the present disclosure, an electronic equipment is provided, comprising the sound producing device described in the second aspect.

Specifically, in the present embodiment, the sound producing device provided by the second aspect of the present disclosure may be provided in the electronic equipment to achieve the sound producing performance of the electronic equipment. Moreover, the sound producing device provided by the present disclosure has a higher acoustic effect, and improves the acoustic function of the electronic equipment. Here, the electronic equipment may be a mobile phone, laptop computer, tablet computer, VR (virtual reality) device, AR (augmented reality) device, TWS (True Wireless Stereo) earphones, smart speaker, etc., which is not limited in the present disclosure.

In order to make the technical solution and corresponding technical effects of the present disclosure clearer, the present disclosure specifically provides the following embodiments and comparative embodiment to illustrate the technical solution.

### Embodiment 1

In the preparation process of the sound absorption material 1 provided in this embodiment, aluminosilicate sol is used as the inorganic adhesive, and the zeolite powder particles use ZSM-5 with a silicon-aluminum mass ratio of 150 and an average particle size of 12 μm. The specific preparation process is as follows:

Step 1: taking 30 g of the above ZSM-5 zeolite powder particles, dispersing them in 70 g of deionized water to make a slurry, and adding 3 g of aluminosilicate sol into the slurry so as to mix the slurry evenly.

In this step, the zeolite powder particles, as the main sound absorption material 1, are dispersed in the deionized water, and the aluminosilicate sol, as the inorganic adhesive, may bind the zeolite powder particles dispersed in deionized water. Here, in order to mix the slurry more uniformly, lg of the dispersant may be added at the same time.

Step 2: preparing the uniformly mixed slurry from step 1 into granular material by spray drying. That is, multiple zeolite powder particles initially form the granular material from the slurry state under the action of the inorganic adhesive.

Step 3: placing the granular material from step 2 in an oven, drying it at a temperature of 80° C. to 120° C. until its mass no longer changes, and placing it in a muffle furnace for high-temperature calcination at a temperature of 200° C. to 800° C. so as to obtain granular sound absorption material 1.

Step 4: testing the crushing resistance of a single particle of the granular sound absorption material 1 obtained in step 3 by means of a spring pressure tester, and its crushing resistance is 0.22N.

Taking 0.2 cc of the above granular sound absorption material 1 and filling it into the rear acoustic cavity 101 of the first sound producing device.

### Embodiment 2

In the preparation process of the sound absorption material 1 provided in this embodiment, aluminosilicate sol is used as the inorganic adhesive, and the zeolite powder particles use ZSM-5 with a silicon-aluminum mass ratio of 150 and an average particle size of 12 μm. The specific preparation process is as follows:

Step 1: taking 30 g of the above ZSM-5 zeolite powder particles, dispersing them in 70 g of deionized water to make a slurry, and adding 3 g of aluminosilicate sol into the slurry so as to mix the slurry evenly.

In this step, the zeolite powder particles, as the main sound absorption material 1, are dispersed in the deionized water, and the aluminosilicate sol, as the inorganic adhesive, may bind the zeolite powder particles dispersed in deionized water. Here, in order to mix the slurry more uniformly, 1 g of the dispersant may be added at the same time.

Step 2: pouring the uniformly mixed slurry from step 1 into a mold, and forming a pre-shaped block material after dehydration. That is, multiple zeolite powder particles initially form block material in the mold under the action of the inorganic adhesive, wherein the prefabricated shape matches the shape of the rear acoustic cavity of the sound producing device.

Step 3: placing the block-shaped material from step 2 in an oven, drying it at a temperature of 80° C. to 120° C. until its mass no longer changes, and placing it in a muffle furnace for high-temperature calcination at a temperature of 200° C. to 800° C. so as to obtain block-shaped sound absorption material 1.

Step 4: testing the crushing resistance of the block-shaped sound absorption material 1 obtained in step 3 by means of a spring pressure tester, and its crushing resistance is 0.45N.

Taking the above block-shaped sound absorption material 1 of 0.2 cc volume and filling it into the rear acoustic cavity 101 of the second sound producing device.

### Comparative Embodiment

In the preparation process of the sound absorption material 1 provided in this comparative embodiment, adding 100 g of ZSM-5 zeolite powder particles into 150 g of deionized water, and adding 10 g of polyacrylate organic adhesive to bind the zeolite powder particles so as to form sound absorbing particles. Here, the silicon-aluminum mass ratio of the zeolite powder particles is 500, and the average particle size is 1.5 μm. After testing, the crushing resistance value of the obtained single sound absorbing particle is 0.07N. Taking 0.2 cc of the above sound absorbing particles and filling them into the rear acoustic cavity 101 of a third sound producing device.

Firstly, comparing the crushing resistance values of the sound absorption materials prepared in the embodiment 1, the embodiment 2, and the comparative embodiment. The comparison results are shown in the following table 1:

| | crushing |
|---|---|
| experimental group | resistance/N |
| embodiment 1 | 0.22 |
| embodiment 2 | 0.45 |
| comparative | 0.07 |
| embodiment | |

It can be seen from the table 1 that the crushing resistance values of the sound absorption materials 1 provided in the embodiments 1 and 2 of the present disclosure are significantly greater than the crushing resistance value of the sound absorption material provided in the comparative embodiment. This indicates that the sound absorption material 1 provided by the present disclosure has higher structural strength, may be applied to the sound producing device that requires high power intensity vibration, and has a broader application range. In addition, the crushing resistance value of the block-shaped sound absorption material 1 provided in embodiment 2 is greater than that of the granular sound absorption material 1 provided in embodiment 1, which indicates that under a certain condition, the crushing resistance value of the sound absorption material 1 provided in the present disclosure may be adjusted by controlling the shape of the sound absorption material 1 so as to meet the needs of different sound producing devices.

Secondly, the following experimental tests are carried out on the sound producing devices in the above embodiments and the comparative embodiment.

It should be noted that in the above embodiments and the comparative embodiment, the model of the sound producing device used is the same. Referring to FIG. 3, the sound producing device is assembled from a housing 10 and a sound producing unit 20. The housing 10 is provided with a front acoustic cavity 102 and a rear acoustic cavity 101 therein, and the sound absorption material 1 is filled in the rear acoustic cavity 101. Additionally, a fourth sound producing device is provided as a control group without any sound absorption material 1 filled in the rear acoustic cavity 101 thereof.

Experiment 1: Impedance tests are conducted on the first, second, third, and fourth sound producing device respectively. Here, the impedance (IMP) refers to a ratio of voltage to current of the electrical signal input to the sound producing device, and the magnitude of the impedance value changes with the frequency of the electrical signal. The frequency of the electrical signal corresponding to the first maximum value of the impedance (IMP) curve in the low-frequency region is the resonant frequency F0 of the sounding device, and the smaller the resonant frequency F0, the better the low-frequency effect of the sounding device.

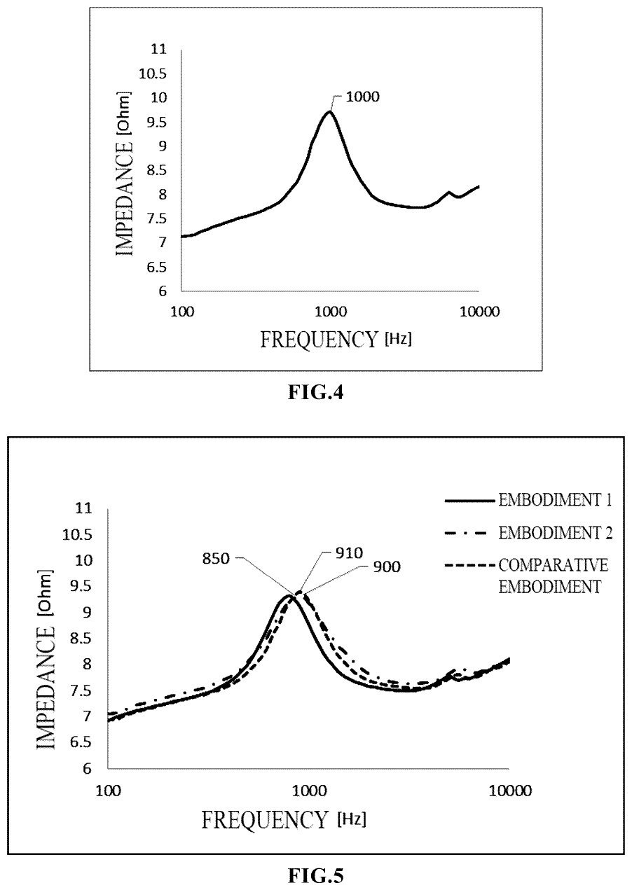

Under the scanning frequency of 100 Hz to 10 kHz, the resonant frequency F0 of each sound producing device is tested to obtain IMP curves shown in FIGS. 4 and 5.

Here, the abscissa represents the vibrational frequency (Hz) of the sound, and the ordinate represents the impedance value of the sound. The frequency at which the impedance value reaches the first peak is the resonant frequency F0 of the sound producing device, and is recorded as the initial acoustic performance of the sound producing device.

From the IMP curves in FIGS. 4 and 5, it can be seen that the fourth sound producing device in the control group, which does not have any sound absorption material 1 filled in the rear acoustic cavity 101, has an F0 of 1000 Hz. In contrast, the first sound producing device provided by the embodiment 1 has an F0 of 850 Hz, the second sound producing device provided by the embodiment 2 has an F0 of 900 Hz, and the third sound producing device provided by the comparative embodiment has an F0 of 910 Hz.

By comparing the resonant frequency F0 of the first, second, and third sound producing devices with the fourth sound producing, it indicates that the sound producing device provided by the present disclosure, which is filled with the sound absorption material 1, significantly reduces the resonant frequency of the sound producing device, thereby enhancing the acoustic performance of the sound producing device; additionally, the sound absorption material 1 provided by the present disclosure has higher structural strength.

Experiment 2: The first, second, and third sound producing devices are subjected to the following reliability experiment.

Placing each sound producing device in an environment with a temperature of 65° C. and a relative humidity of 95% RH, and applying a voltage of 3.5V and a pink noise signal for continuous operation for 120 hours.

After the above, testing the resonant frequency F0 of each sound producing device and recording it as the post-experiment acoustic performance; then disassembling each sound producing device to observe the breakage of the sound absorption material 1 in the rear acoustic chamber 101.

From the results of the experiment 1 and the experiment 2, it can be seen that the acoustic performance of each sound producing device before and after the reliability tests and the breakage of the sound absorption material 1 are in table 2 below:

| | | | | Powder |
|---|---|---|---|---|
| | | acoustic | | shedding |
| | initial | performance | | condition |
| | acoustic | after | change | of rear |
| experimental | performance | experiment | in F0 | acoustic |
| group | (Hz) | (Hz) | (Hz) | cavity |
| embodiment 1 | 850 | 865 | 15 | OK |
| embodiment 2 | 900 | 902 | 2 | OK |
| comparative | 910 | 946 | 36 | crushed |
| embodiment | | | | powder |

It can be seen from the comparison that the change in resonant frequency F0 of the first sound producing device provided by the embodiment 1 before and after the reliability test is 15 Hz, and for the second sound producing device provided by the embodiment 2, it is 2 Hz and is relatively small. In contrast, the change in F0 for the third sound producing device provided by the comparative embodiment is 36 Hz, and is relatively large. This indicates that the sound absorption material 1 provided by the present disclosure in different shapes may all withstand high temperature and high humidity environments, exhibit better environmental tolerance, and thus provide better acoustic effect for the sound producing device.

Furthermore, upon disassembling the devices, it was found that the third acoustic device provided by the comparative embodiment has more crushed powder scattered in the rear acoustic cavity 101 of the speaker or entering the magnetic circuit of the sound producing unit 20 after the experiment, indicating crushing of the sound absorption material 1. However, the sound absorption material 1 provided by the embodiments 1 and 2 does not show any crushing after the experiment, further indicating that the sound absorption material 1 provided by the present disclosure has higher structural strength and may enhance the acoustic performance of the sound producing device.

Experiment 3: The first, second, and third sound producing devices are subjected to the following reliability experiment.

Placing each sound producing device in an environment with a temperature of −20° C., applying a voltage of 3.5V, and continuously energizing for 120 h under the condition of scanning frequency of 400 Hz-1000 Hz and 10s log double.

From the results of the experiment 1 and the experiment 3, it can be seen that the acoustic performance of each sound producing device before and after the reliability tests and the breakage of the sound absorption material 1 are in table 3 below:

| | | | | Powder |
|---|---|---|---|---|
| | | acoustic | | shedding |
| | initial | performance | | condition |
| | acoustic | after | change | of rear |
| experimental | performance | experiment | in F0 | acoustic |
| group | (Hz) | (Hz) | (Hz) | cavity |
| embodiment 1 | 850 | 866 | 16 | OK |
| embodiment 2 | 900 | 905 | 5 | OK |
| comparative | 910 | 988 | 78 | crushed |
| embodiment | | | | powder |

It can be seen from the comparison that the change in resonant frequency F0 of the first sound producing device provided by the embodiment 1 before and after the reliability test is 16 Hz, and for the second sound producing device provided by the embodiment 2, it is 5 Hz and is relatively small. In contrast, the change in F0 for the third sound producing device provided by the comparative embodiment is 78 Hz, and is relatively large, which has already exceeded the standard frame line (60 Hz). This indicates that the sound absorption material 1 provided by the present disclosure in different shapes may all withstand low temperature and high humidity environments, exhibit better environmental tolerance, and thus provide better acoustic effect for the sound producing device.

Furthermore, upon disassembling the devices, it was found that the third acoustic device provided by the comparative embodiment has more crushed powder scattered in the rear acoustic cavity 101 of the speaker or entering the magnetic circuit of the sound producing unit 20 after the experiment, indicating crushing of the sound absorption material 1. However, the sound absorption material 1 provided by the embodiments 1 and 2 does not show any crushing after the experiment, further indicating that the sound absorption material 1 provided by the present disclosure has higher structural strength and may enhance the acoustic performance of the sound producing device.

From the experimental results of the above embodiments and the comparative embodiment, it can be seen that that the sound absorption material 1 provided by the present disclosure has higher strength, is less prone to be crushed, and may withstand vibrations of higher power intensity and environmental tolerance, ensuring the acoustic performance of the sound absorption material 1.

The embodiments described above primarily highlight the differences between the embodiments, and different optimization features between the embodiments can be combined to form a better embodiment as long as they are not contradictory, which will not be further elaborated herein for the sake of brevity.

Although some specific embodiments of the present disclosure have been detailed through examples, those skilled in the art should understand that the above examples are only for illustrative purposes and are not intended to limit the scope of the present disclosure. Those skilled in the art should understand that the above embodiments may be modified without departing from the scope and spirit of the present disclosure. The scope of the present disclosure is defined by the appended claims.

1. A sound absorption material, comprising:
zeolite powder particles with an average particle size>10 μm and a silicon-to-aluminum mass ratio<200, and
an inorganic adhesive configured to bind a plurality of the zeolite powder particles into the sound absorption material,
wherein the sound absorption material has a crushing resistance in a range of from 0.1N to 5N.

2. The sound absorption material according to claim 1, wherein in a temperature range from −40° C. to 200° C., the sound absorption material has a change rate of the crushing resistance≤10%.

3. The sound absorption material according to claim 1, wherein the sound absorption material has macroporous structures with an average pore size≥100 nm.

4. The sound absorption material according to claim 3, wherein a pore volume of the macroporous structures constitutes at least 50% of a total pore volume of the sound absorption material.

5. The sound absorption material according to claim 1, wherein the zeolite powder particles have a crystallinity≥80%.

6. The sound absorption material according to claim 1, wherein the zeolite powder particles have a specific surface area≥100 m²/g.

7. The sound absorption material according to claim 1, wherein the zeolite powder particles have pore structures with a pore size of 0.5 nm to 3 nm.

8. The sound absorption material according to claim 1, wherein the zeolite powder particles have at least one of a MOR, MFI, or FER crystal structure.

9. The sound absorption material according to claim 1, wherein a mass of the inorganic adhesive constitutes 1% to 30% of a total mass of the sound absorption material.

10. The sound absorption material according to claim 1, wherein the inorganic adhesive comprises at least one of inorganic salts, inorganic acids, inorganic bases, metal oxides, and hydroxides.

11. The sound absorption material according to claim 1, wherein the sound absorption material has a bulk density≥0.3 g/ml.

12. The sound absorption material according to claim 1, wherein the sound absorption material is quasi-spherical, ellipsoidal, rod-like, cubic, or irregularly shaped;
if the sound absorption material is quasi-spherical, the sound absorption material has a diameter from 100 μm to 800 μm.

13. The sound absorption material according to claim 1, further comprises a dispersant;
wherein the dispersant comprises at least one of sodium dodecyl sulfate, dodecyl benzenesulfonic acid sodium, tri-ethyl-hexyl phosphate, methyl-pentanol, polyacrylamide, fatty acid polyethylene glycol ester, and polyether.

14. The sound absorption material according to claim 13, wherein a mass ratio of the dispersant in a total mass of the sound absorption material is ≤10%.

15. A sound producing device, comprising:
a sound producing unit, a housing, and a sound absorption material according to claim 1;
the sound producing unit is located inside the housing and engaged with the housing to define a front acoustic cavity and a rear acoustic cavity, and the sound absorption material is filled in the rear acoustic cavity and/or the front acoustic cavity.

16. An electronic equipment, comprising a sound producing device according to claim 15.
